(19) United States
(12) Patent Application Publication
(10) Pub. No.: US 2017/0002573 A1
(43) Pub. Date: Jan. 5, 2017

(54) LAMINATE FLOOR ELEMENT

(71) Applicants: RKW SE, Frankenthal (DE); SURTECO SE, Buttenwiesen-Pfaffenhofen (DE)

(72) Inventors: Seidel Henning, Valenciennes (FR); Leonhard Meier, Babensham (DE); Robert Voggenauer, Wasserburg (DE); Rolf Warda, Koln (DE); Stephan Schunk, Munster (DE); TIlo Wachs, Remagen (DE)

(73) Assignees: RKW SE, Frankenthal (DE); Surteco SE, Buttenwiesen-Pfaffenhofen (DE)

(21) Appl. No.: 15/107,245

(22) PCT Filed: Dec. 17, 2014
(86) PCT No.: PCT/EP2014/003389

§ 371 Date: Jun. 22, 2016

(30) Foreign Application Priority Data
Dec. 22, 2013 (DE) 10 2013 021 779.2

(51) Int. Cl. E04F 15/10; B32B 21/08; B32B 27/08; B32B 38/00; B32B 27/40; B32B 37/12; B32B 7/12; B32B 21/02; B32B 27/32

(52) U.S. Cl. CPC E04F 15/107; B32B 21/02; B32B 21/08; B32B 27/08; B32B 27/32; B32B 27/40; B32B 37/12; B32B 7/12; B32B 38/0012; E04F 15/02038

(57) ABSTRACT

The invention relates to a laminate floor element including a support (1) on which is decorative layer (3) is arranged. This decorative layer (3) includes at least one microporous thermoplastic film.

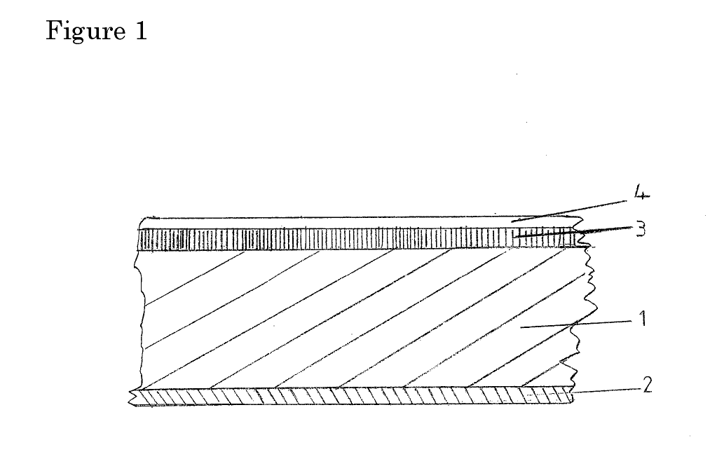

### BACKGROUND

The invention relates to a laminate floor element with a carrier on which a decorative layer is arranged.

Laminate floors have been known for many decades. During the laying of laminate floors, elements which may by way of example be of panel design or of floorboard design are placed alongside one another. Use is frequently made here of click systems which connect the individual laminate floor elements to one another.

Laminate floor elements are produced by applying a decorative layer onto a carrier. There are frequently patterns printed on the decorative layer, examples being wood effects.

EP 2 263 867 B1 describes a laminate floor element with a carrier on which there is an upper layer applied. On the external side of the upper layer there is a film layer provided, made of a resilient plastic. Films used here are made by way of example of polypropylene, polyethylene, polyurethane, and/or polyvinyl chloride.

### SUMMARY

It is an object of the present invention to provide a laminate floor element which when used as floor-covering ensures good soundproofing and attractive haptic properties. Another intention is to achieve an attractive appearance. The laminate floor element is moreover intended to feature low susceptibility to wear and the lowest possible density. It is moreover intended to be amenable to production at the lowest possible cost.

This object is achieved by the invention in that the decorative layer comprises at least one microporous thermoplastic film.

The use of a microporous thermoplastic film as decorative layer offers particular advantages. Good soundproofing is provided by the pore structure.

Indeed, when the laminate floors of the invention are used in some applications there may be no need for any additional solid-borne-sound insulation. The laminate floor of the invention moreover ensures attractive haptic properties. The insulation properties of the microporous film are better than those of conventional decorative layers, and therefore the perception on contact with the floor is that the surface is warm.

The prior art additionally discloses microporous layers which are used not as decorative layers but has membranes. For instance, EP 1 400 348 A2 describes a roofing underlay. This comprises a breathable material having a membrane. The material comprises a fibrous polymeric spunbond ply. The membrane and the fibrous polymeric spunbond ply have been laminated together. The membrane comprises a microperforated metallized foil.

The use of thermoplastic films with apertures has hitherto been rejected on principle because it was assumed that the apertures absorb printing ink, thus distorting the printed image to such an extent that films with apertures have been regarded as having poor printability. In particular, when the laminate floor sector requires filigree decorative wood patterns, the conventional decorative layers used comprise polymer films having an uninterrupted surface.

Very surprisingly, it has now been found that microporous thermoplastic films have particularly advantageous properties when used as decorative layer in floor laminates. It has been found possible here to reduce the consumption of printing inks when comparison is made with conventional papers. The microporous structures lead to particularly high opacity, believed to be attributable to refractive effects.

The microporosity leads to a reduction of chemical interactions. In the case of single-color laminate, it has been found that there is actually no requirement for printing because, even with no printing, use of a colored microporous thermoplastic decorative film led to a particularly attractive appearance.

In one variant of the invention there is an overlay arranged on the microporous decorative layer. This outer layer forms the uppermost layer of the laminate floor. It is possible by way of example to use a lacquer as an overlay.

In one particularly advantageous variant of the invention, the overlay used comprises at least one thermoplastic film or coating made of, for example, thermoplastic polyurethane and/or of thermoplastic elastomers, polypropylene, and/or polyethylene. Preference is given here to a highly transparent polyurethane film. It has been found here that particularly good protection with respect to discoloration on exposure to light and heat is achieved when an aliphatic isocyanate is used as isocyanate component to produce the thermoplastic polyurethane.

The thickness of the overlay of the invention, based on a thermoplastic polyurethane, is from 30 to 500 μm, preferably from 40 to 150 μm. This overlay is extremely abrasion- and scratch-resistant. In one preferred variant, an adhesive bonds the overlay and the microporous thermoplastic decorative layer to one another.

In particular, oriented microporous films have been found to be suitable as decorative layer for laminate floor elements. These oriented microporous films are produced by stretching. A film is stretched monoaxially or biaxially in an orientation step with stretching ratios of from 1.2 to 10 in each stretching direction. The stretching processes can use rolls and/or tenter frames, or other suitable stretching techniques.

It is preferable that the decorative layer comprises cells with microcavities, and comprises connecting pores between the cells, where the average diameter of the pores is less than 10 μm, preferably less than 5 μm, particularly preferably less than 2 μm. The diameter of the pores is determined by mercury porosimetry.

Microporous films with water vapor transmission above 500 g/m²/24 h have proven to be particularly suitable. Water vapor transmission is determined here in accordance with ASTM E96, method E.

However, it is also possible to conceive of variants using microporous films with substantially lower water vapor transmissions.

It is preferable to use, as decorative layer, a microporous thermoplastic film produced by a process comprising at least the following steps:
1) formation of a film made of a polymeric composition, and
2) stretching of the film in at least one direction.

Films which have proven to be particularly advantageous here are those with stretching ratio from 1.2 to 10. This stretching ratio leads to a microporous structure which is very advantageous for the use as decorative films in laminate floors.

In one advantageous variant of the invention, the film formed from the polymeric composition is heated before stretching, preferably to a temperature of from 35° to 140° C.

The polymeric composition used to form the film is preferably comprised of an ethylene-propylene block copolymer. This composition is termed component A hereinafter, and the quantity present thereof is from 5 to 95 parts by weight. It is preferably an ethylene-propylene block copolymer with from 10 to 50% by weight ethylene content.

It has proven advantageous for the polymeric composition to comprise, as supplement or alternative, a component B which is a propylene homopolymer or a random copolymer of propylene. This preferably comprises up to 10% by weight of a comonomer of ethylene or of an a-olefin having from 4 to 8 carbon atoms. The quantity of component B present in the polymeric composition is preferably from 5 to 40 parts by weight.

In one variant of the invention, the polymeric composition moreover comprises from 1 to 20 parts by weight of a component C. Component C is a polypropylene which has low molecular weight and which has a melt viscosity of from 50 to 1000 poise, measured at a shear rate of 136 sec⁻¹ and 190° C. Component C can be provided via component B if the molecular weight distribution of component B is sufficiently broad that the portion of component C required in the polymeric composition is present in the low-molecular-weight material of component B.

There can moreover be, present in the polymeric composition, a component D comprising calcium carbonate. The quantity of component D present can be from 0 to 30 parts by weight per 100 parts by weight of components A, B, and C.

Very surprisingly, it has been found that microporous films are particularly suitable as decorative layer of laminate floor elements when these are produced from a polymeric composition which comprises no inorganic filler, for example calcium carbonate. These filler-free microporous thermoplastic films have proven to be particularly valuable during printing, because there are no problematic inclusions present.

This filler-free microporous film is preferably produced by using, in the polymeric composition, a component E which comprises a nucleating agent, preferably a beta-spherulite nucleating agent. In particular, from 0 to 50 ppm of nucleating agent has proven to be advantageous in the polymeric composition.

The density of the microporous thermoplastic decorative layer of the invention is preferably less than 800 kg/m³, in particular less than 750 kg/m³. The thickness of the microporous film is preferably more than 10 μm and less than 500 μm, in particular more than 30 μm and less than 200 μm.

The laminate floor elements of the invention are produced by first forming a film made of a polymeric composition. This film is stretched, preferably with a stretching ratio of from 1.2 to 10. The microporous film is printed and applied on the carrier of the laminate floor.

The application process can use an adhesive and/or pressure and/or heat. The microporous thermoplastic decorative layer of the invention can therefore be bonded to carriers in a lamination procedure, optionally with use of resins Examples of carriers that can be used are particleboard and medium-density (MDF) and high-density (HDF) fiberboard, and also thermoplastic carrier sheets.

For the bonding of the microporous outer layer to the carrier it is preferable to use a moisture-crosslinking, isocyanate-free hot melt adhesive with high grab and short open time.

The overlay can then be applied as outer layer, for example in the form of a lacquer.

In one particularly advantageous variant, a process is used in which the microporous thermoplastic outer layer is first bonded to an overlay. A material that proves to be particularly advantageous here is a film laminate made of the microporous thermoplastic film and of a polyurethane film made of a thermoplastic polyurethane. Once the film laminate has been produced, this is preferably bonded by an adhesive to the carrier of the laminate floor.

In an alternative variant of the invention, the overlay is reverse-side-printed, and bonded to an unprinted microporous thermoplastic film as decorative layer. It is preferable here to use an overlay made of a polyurethane film. The polyurethane film is printed on its underside. Its upper side can moreover be embossed. The polyurethane film with printed underside and embossed upper side is bonded to the microporous film. A composite is thus produced, made of the carrier, the microporous film, and the overlay.

Other features and advantages of the invention are apparent from the description of an embodiment with reference to a drawing, and from the drawing itself.

### BRIEF DESCRIPTION OF THE DRAWINGS

The single figure here is a sectional view of a laminate floor element.

### DETAILED DESCRIPTION OF THE PREFERRED EMBODIMENTS

The laminate floor element in the embodiment is a laminate floor panel. The laminate floor element has the shape of an elongate rectangle, and its thickness is more than 5 mm.

The laminate floor element comprises a carrier 1. In the embodiment the carrier 1 is a board made of HDF or MDF. The thickness of the carrier 1 is preferably more than 4 mm. The edge of the laminate floor element in the region of the carrier 1 has a particular profile, but this is not shown. The particular profile permits interlocking and/or frictional connection of the laminate floor elements. The embodiment here uses a click-connection profile, in the manner of a tongue-and-groove system.

There is a balancing layer 2 arranged on the underside. The balancing layer 2 is a layer contributing to the dimensional stability of the carrier 1. The balancing layer 2 serves to prevent deformation of the laminate when it is exposed to the bending forces that arise.

The laminate floor element in the invention comprises a decorative layer 3 which comprises at least one microporous film. In the embodiment the decorative layer 3 is composed of the microporous film itself. An adhesive bonds the decorative layer 3 to the carrier 1.

There is an overlay 4 arranged on the decorative layer 3. The overlay 4 in the embodiment is comprised of a resilient polyurethane film. The polyurethane forming the polyurethane film here is a polyurethane based on aliphatic isocyanate. An adhesive bonds the overlay 4 to the decorative layer 3.

The microporous thermoplastic decorative layer 3 of the invention comprises cells with microcavities and with connecting pores between the cells.

The microporous decorative layer 3 is produced by a process comprising the following steps:
formation of a film made of a polymeric composition,
heating of the film at a temperature of from 35° to 140° C.,
stretching of the heated film in at least one direction with a stretching ratio of from 1.2 to 10.

The polymeric composition comprises
from 40 to 90 parts by weight of a component A which comprises an ethylene-propylene block copolymer with from 10 to 50% by weight ethylene content,
from 5 to 40 parts by weight of a component B which comprises a propylene homopolymer or a random copolymer of propylene with up to 10% by weight of a comonomer of ethylene or of an α-olefin having from 4 to 8 carbon atoms,
from 1 to 20 parts by weight of a component C which comprises a polypropylene which has low molecular weight and which has a melt viscosity of from 50 to 1000 poise, measured at a shear rate of 136 sec⁻¹ and 190° C., where component C can be provided via component B if the molecular weight distribution of component B is sufficiently broad that the portion of component C required in the polymeric composition is present in the low-molecular-weight material of component B;
from 0 to 30 parts by weight per 100 parts by weight of components A, B, and C, of a component D which comprises calcium carbonate,
from 0 to 50 ppm per 100 parts by weight of components A, B, and C of a component E which comprises a beta-spherulite nucleating agent, with the proviso that the quantity of component C present is
a) from 5 to 20 parts by weight when the polymeric composition is in essence free from component D or components D and E,
b) from 1 to 10 parts by weight when the polymeric composition comprises from 0.1 to 10 ppm of component E and from 5 to 30 parts by weight of component D.

The film formed from the polymeric composition is heated by a suitable means of heating in such a way that the film reaches the desired temperature in the shortest possible time, while the properties of the film are retained. Heating rolls are typically used to heat the film to the desired orientation temperature.

A temperature of from 40° to 95° C. is sufficient for films which are stretched simultaneously in both directions. Films formed from compositions based on polypropylene are preferably heated to from 70° to 85° C.

The desired temperature for machine-direction orientation can extend from 40° to 95° C., with a preferred temperature range of from 60° to 70° C.

The desired temperature for the subsequent transverse-direction orientation can extend from 75° to 140° C., with a preferred temperature range of from 105° to 130° C.

Attempts to orient films at temperatures outside of the preferred temperature ranges typically do not produce films with the desired porosity properties and strength properties.

The composition of the film influences not only the type of orientation but also the orientation temperature. Films which comprise ethylene-propylene block copolymer, polypropylene homopolymer, or a random copolymer of propylene and polyolefin with low molecular weight are preferably heated to a temperature of from 50° to 80° C.

Films which comprise ethylene-propylene block copolymer, propylene homopolymer, or a random copolymer, polyolefin with low molecular weight, a beta-spherulite nucleating agent, and/or an inorganic filler, for example calcium carbonate, are preferably heated to a temperature in the range from 35° to 140° C.

The heated film can be stretched monoaxially or biaxially in the orientation step. Monoaxial stretching can be carried out by using rolls together with a roll and/or with a tension frame to hold the film. Biaxial stretching can include successive monoaxial stretching steps. These can comprise stretching in longitudinal direction by rolls and/or transverse stretching by tenter frames. In the case of biaxial stretching, the stretching ratio in the longitudinal or machine direction and in the transverse direction can be identical or different. The stretching ratios in the two directions are generally identical. The stretching ratio for both monoaxial and biaxial orientation can be from 1.2 to 10 in each stretching direction.

The quantity of nucleating agent for forming the porous decorative layer of the floor laminate element depends on the effectiveness of said agent. The embodiment uses a beta-spherulite nucleating agent which comprises a quinacridone dye, hereinafter termed “Q dye”.

The quantity of the Q dye present in the polymeric compositions can extend from 0.01 to 50 ppm by weight. The quantity of nucleating agent used is sufficient to induce formation of 20% by weight or more of beta-spherulites in the film. It is preferable to use from 0.1 to 30 ppm by weight of the Q dye.

1. A laminate floor element comprising a carrier (1) formed from at least one of particleboard, medium-density (MDF), high-density (HDF) fiberboard, or thermoplastic carrier sheets; a decorative layer (3) arranged on the carrier, and the decorative layer (3) comprises at least one microporous thermoplastic film.

2. The laminate floor element as claimed in claim 1, further comprising an overlay (4) arranged on the decorative layer (3), the overlay (4) comprises at least one thermoplastic film.

3. The laminate floor element as claimed in claim 1, wherein the microporous film comprises cells with microcavities, and comprises connecting pores between the cells.

4. The laminate floor element as claimed in claim 3, wherein an average diameter of the pores of the microporous film is less than 10 μm.

5. The laminate floor element as claimed in claim 1, wherein a water vapor transmission of the microporous film, determined in accordance with ASTM E96 method E, is 500 g/m²/24 h or greater.

6. The laminate floor element as claimed in claim 1, wherein the microporous film has been produced by a process comprising the following steps:
forming a film made of a polymeric composition, and
stretching the film in at least one direction.

7. The laminate floor element as claimed in claim 6, wherein the polymeric composition comprises at least one of an ethylene-propylene component or a propylene component.

8. The laminate floor element as claimed in claim 6, wherein the polymeric composition comprises no inorganic filler.

9. The laminate floor element as claimed in claim 6, wherein the polymeric composition comprises a nucleating agent.

10. The laminate floor element as claimed in claim 1, wherein a density of the microporous film is less than 800 kg/m³.

11. The laminate floor element as claimed in claim 1, wherein a thickness of the microporous film is more than 10 μm and less than 500 μm, in particular more than 30 μm and less than 200 μm.

12. A process for the production of a laminate floor element, comprising the following steps:
forming a film made of a polymeric composition,
stretching the film in at least one direction to form microporous structures,
applying the film as decorative layer (3) onto a carrier (1), and
bonding the decorative layer (1) to the carrier (1) in a laminating procedure.

13. The process as claimed in claim 12, wherein in order to form microporous structures, the film is stretched with a stretching ratio of from 1.2 to 10 in each stretching direction.

14. The process as claimed in claim 12, wherein the microporous film is printed.

15. The process as claimed in claim 12, further comprising applying an overlay (4) onto the microporous film, the overlay comprising at least one polyurethane film made of a thermoplastic polyurethane.

16. The laminate floor element as claimed in claim 2, wherein the overlay (4) comprises a polyurethane film made of a thermoplastic polyurethane.

17. The laminate floor element as claimed in claim 9, wherein the nucleating agent is a beta-spherulite nucleating agent.
